(19) United States
(12) Patent Application Publication
(10) Pub. No.: US 2026/0200617 A1
(43) Pub. Date: Jul. 16, 2026

(54) METHOD AND APPARATUS FOR PACKAGING ARTICLES AND USE OF A FILM FOR THIS METHOD

(71) Applicant: Jens Kallfass, Nürtingen (DE)

(72) Inventor: Jens Kallfass, Nürtingen (DE)

(21) Appl. No.: 19/385,887

(22) Filed: Nov. 11, 2025

(30) Foreign Application Priority Data
Nov. 12, 2024 (DE) 102024133055.4

(51) Int. Cl. B65B 31/04; B65B 11/50; B65B 25/06; B65B 51/14

(52) U.S. Cl. CPC B65B 31/048; B65B 11/50; B65B 25/062; B65B 51/14

(57) ABSTRACT

In a method for packaging an articles in a barrier film, a tray together with the article thereon is completely wrapped in the barrier film. Either a negative pressure can be generated in the film bag generated and the film bag can then be sealed with negative pressure inside it. Alternatively, the finished film bag can have a pressure relief valve or an air outlet hole provided on the barrier film. The film bag is sealed by means of thermal welding of at least two layers of the barrier film lying one above the other, wherein the film bag can be in close contact with the tray with the article thereon. The barrier film is two-layer with a thin layer of EVOH film between them in order to be recyclable.

### CROSS-REFERENCE TO RELATED APPLICATION

The present application claims priority to German Patent Application No. 102024133055.4, filed Nov. 12, 2024, the entirety of which is incorporated herein by reference.

### AREA OF APPLICATION AND PRIOR ART

The invention relates to a method for packaging an article in a film or with a film, wherein the article is placed on a tray, and this tray with the article is then wrapped in the film. Furthermore, the invention relates to a use of a so-called barrier film for packaging an article on a tray according to this method. Finally, the invention also relates to a device using which the method in accordance with the invention can be performed.

It is known how to package food, for example, as articles, directly and only in film. It is also known how to place food as articles onto a tray, for example of cardboard, or a multi-layer plastic tray, wherein the tray has at the top a wide rim all the way round. A multi-layer film is then glued or welded onto this rim for sealing. For that purpose, this film is designed such that it does not allow any germs, bacteria or too much oxygen to pass from the outside to the inside and to reach the food to be packaged. Furthermore, these films are in some cases thick, so that the aforementioned bonding type to the rim of the tray is durable and stable. The disadvantage of this multi-layer solution is that the material is not recyclable. A lid may consist of the material LDPE/EVOH/PP with a thickness of 55 μm, a tray of the material PET or LDPE.

Furthermore, so-called EVOH shrink films, which may also be so-called barrier films, are known for example from EP 3 530 457 A1. They too can also be used for packaging of food placed on trays. After packaging and sealing of packaging, they can be heat-shrunk in the known manner.

### OBJECT AND SOLUTION

The object underlying the invention is to provide a method as mentioned at the outset, a corresponding use, and a corresponding device with which problems of the prior art can be solved, and it is in particular possible to package food as articles on a tray securely, storably and as free as possible of germs and as well as possible, wherein the packaging is preferably as far as possible completely recyclable, with a tray being possibly compostable.

This object is achieved by a method having the features of claim 1, by a use having the features of claim 19, and by a device having the features of claim 20. Advantageous and preferred embodiments of the invention are the subject matter of the further claims and are explained in greater detail below. Some features are described only for the method, only for the use or only for the device. Regardless of this, however, they should be able to apply both to the method and to such a use and to a corresponding device, independently and without relying on one another. The wording of the claims is incorporated into the content of the description by express reference.

The method is used to package an article in a film, wherein the article is arranged on a tray. There can also be several, in particular similar or identical articles, on a single tray. Preferably, however, it is a single tray in a single film packaging. The film can be a polyolefin film or is an aforementioned barrier film, preferably an EVOH film, optionally also a multi-layer film with one layer of EVOH film, advantageously as a middle layer between two other film layers or paper layers. It is penetrable for bacteria and germs only with great difficulty or not at all. It may also be almost impenetrable or 95% to 99% impenetrable for atmospheric gases such as oxygen, carbon dioxide or the like. It is preferably airtight. The method for packaging has the steps set forth in the following. The film or barrier film may thus be a film-on-film or a film-on-paper system, whereby a barrier layer and a sealing layer are advantageously formed. A paper-on-paper system may also be used as a film or as a barrier film and is a so-called sealable paper, which then has a barrier layer and a sealing layer which consist of plastic, and hence the entire paper-on-paper system can also be regarded as a film in the meaning of the present application. In the aforementioned systems, the paper webs are brought together, and then sealed or welded together by means of pressure and heat in the same way as films. Sealable papers of this type are available for example from the companies Sappi Group or Mondi plc.

In step A), a tray is provided on which at least one aforementioned article is located. The tray projects beyond the article at the sides, at least when seen in the plan view. Advantageously, the tray may also be higher than the article, i.e. project above it, but this is not essential. Alternatively, the tray may be matched to the article(s) to be packaged, wherein it may also be smaller or of the same size. The size of the tray in terms of its contact surface should not diverge from the size of the article by more than 10%. Preferably, the tray is larger than or projects beyond the article when flat.

In step B), the tray with the article thereon is completely covered by or wrapped in the barrier film, and thus is completely inside the film. The film may however still be open at least at one point or on one side along a side of the tray. On the one hand, this is in any case an interim stage during packaging. On the other hand, this can be utilized since this allows several possibilities for sealing, preferably airtight sealing, of the film, or of the film bag created from and formed by it with the tray and the article inside it.

Accordingly, the film bag is generally made or sealed, preferably sealed airtight, to make the packaged article or the packaged food storable for longer. A first possibility for sealing the barrier film around the tray with the article thereon may entail a negative pressure being generated in the film bag thus formed. This generation of a negative pressure can be achieved in several ways, explained in more detail in the following. The negative pressure may be used such that the film bag slightly, largely or completely conforms to the tray with the article thereon. According to step C), the film bag is sealed, advantageously with a negative pressure inside it, wherein the negative pressure may be advantageously between 0.1 bar and 0.5 bar.

Alternatively to the stated step C), in a step D) a complete sealing of the barrier film around the tray with the article thereon to form a film bag can provide for a pressure relief valve to be attached to the finished film bag. Such a pressure relief valve may be of similar design to that known for example from packaging for coffee beans or the like. It can be advantageously attached on an upper side of the film bag, particularly advantageously offset towards one side or attached such that it is not arranged on that point of the packaging or film bag which is highest due to the packaged article.

The film bag is sealed, or the barrier film forms the film bag during sealing, in that at least two layers of the barrier film are placed one above the other and are bonded by means of thermal welding, with the film bag therefore being thermally welded and sealed in this way. This can generally be done in the known manner, as explained in more detail in the following. The barrier film or the film bag is neither heat-shrunk nor treated with a significant increase in temperature or heating up. Per se, the barrier film or the film bag should retain their original size.

In a later thermal effect, for example due to a warm environment, air enclosed in the film bag can in principle expand due to being heated up. If according to step C) a negative pressure or a sufficient negative pressure is generated inside film bag, this negative pressure atmosphere is not greatly, or not at all, expanded by possibly being heated up. At least it does not do so sufficiently to be a problem. The tray with the at least one article thereon is packed firmly and tightly inside the film bag, advantageously under tension.

A pressure relief valve may be used to release or drain off air, present in the film bag and not under positive pressure, that is expanding due to possible heating up. Since the pressure relief valve is a one-way valve, no ambient air is sucked in during cooling, the result being packaging inside a film bag. The pressure relief valve simply remains on the film bag.

The scope of the invention thus contains several possibilities for achieving the aim of an article on a tray packaged in a barrier film.

The measure of step D) can serve to reduce or prevent effects on the barrier film due to temperature-related expansion of air or gases present in the film bag.

As a further alternative to step D), gas and/or air can be pressed out of the film bag, either partially or largely, for example 10% to 40% or even up to 60%, prior to its complete sealing. This can preferably be achieved in that pressure is applied to the film bag from one side, in particular from above. This is done particularly advantageously over a surface and softly or flexibly, so that excess air or gas can be pressed out of the film bag or the latter is pressed slightly flatter. The effect is similar to when air is extracted from the film bag shortly before its complete sealing. During possible later heating up, the airtight-sealed film bag is inflated only slightly or not at all due to the air or gas it contains.

In one embodiment of the invention, the barrier film can have a thickness of between 10 μm and 100 μm, preferably between 10 μm and 50 μm or between 20 μm and 30 μm. Due to the relatively low thickness, the quantity of resultant plastic waste can be reduced. The film for the film bag or for packaging can either consist of two separate flat film webs, wherein the two webs advantageously have the same width and are guided one above the other at a slight distance apart, wherein the tray with the article to be packaged in it or on it is between the two webs. With the method, four airtight weld seams are then formed in order to produce the film bag, wherein these weld seams preferably adjoin one another and extend all the way around the film bag. Alternatively, a so-called half-tube can be formed from a single web of flat film or formed in such a way that a single web of flat film is in effect folded on itself along a longitudinal side. The result is a so-called half-tube. The tray with the article in it is then inserted into this half-tube in order to be finally packaged as a film bag, wherein only three weld seams are formed for this. Where the fourth weld seam was in a method with two separate webs of flat film, the film web is effectively continuous due to it being folded on itself. The weld seams formed are then on each of the ends of a packaging or film bag in the movement direction, and at the side along one of the longitudinal sides. In a further embodiment of the invention, a barrier film is advantageously sealable or can be sealed or welded by heat, either with other materials or advantageously with itself. To do so, it can have two film layers, advantageously of PE, which have a so-called barrier layer between them. These film layers and the barrier layer are firmly bonded to one another. The barrier film can be co-extruded.

In one development of the invention, the barrier film can be selected from the group: EVOH, PO, LDPE, HDPE, VCI, ESD, or at least one layer of a multi-layer barrier film can consist thereof.

In a further embodiment of the invention, it can be provided that a negative pressure is generated in the film bag, such that it is sealed with negative pressure inside it. The negative pressure can be generated and maintained during the complete sealing operation. It can fluctuate while doing so. In some circumstances, the negative pressure can also be generated, or this can be attempted, such that it is actively being generated until shortly before sealing of the film bag or welding of film layers, for example by pressing on the film bag or by extraction, which is however then just stopped. Shortly after stopping, preferably after a maximum of 2 seconds or of 1 second, the film bag can be completely sealed. Within this very short time, a complete pressure equalization is not possible, so that there is still a sufficient negative pressure present in the interior of the sealed film bag. Air can thus be extracted or can escape through the last remaining opening in the film bag, the opening not being sealed, preferably airtight, until practically the last moment.

Preferably, the negative pressure which has been generated or which prevails in step C) or in step D) inside the film bag after complete sealing can be between 0.01 bar and 0.9 bar, particularly preferably between 0.1 bar and 0.5 bar. This is sufficient. For this negative pressure too, airtight sealing is advantageous or even necessary.

In an advantageous embodiment of the invention, it can be provided that the tray with the article thereon is first inserted into the barrier film such that the barrier film is underneath the tray and on a first lateral side upwardly overlaps onto the tray together with the article thereon over the full length and without interruption. On the opposite second lateral side, both film layers can project beyond the tray and the article thereon. This is then a so-called film half-tube, which can be created for example according to EP 806 346 A2 and has the advantage that only a single film web is needed and must be welded along only one single lateral side, i.e. the first lateral side. Then the two film layers on this second lateral side can be welded to one another, in particular at a distance from the second lateral side of the tray which is less than 20% or less than 10% of the distance of the two lateral sides from one another. Excess film outside the film bag can be cut off here.

In an advantageous embodiment of the invention, welding takes place at least on the second lateral side, advantageously on both lateral sides, during movement. Particularly advantageously, it takes place constantly or at a constant speed or at least without interruption.

Advantageously, it can be provided that welding, in particular during movement, is done by means of a side welding unit in accordance with the invention and described in more detail in the following.

During packaging into the barrier film or into the film bag, the tray with the article thereon can be moved along a transport direction, wherein the two film layers are bonded to one another in a direction transverse to that transport direction or are bonded by welding. This may already have been done on a front side of the tray, seen in the transport direction, which is also known from the aforementioned prior art for serial packaging. Preferably, the film bag can be finally sealed by welding of the two film layers to one another at a rear side opposite to the front side, in effect forming the last weld seam.

In one embodiment of the invention, the interior of the film bag can contain normal air, i.e. not an inert gas, preferably at a negative pressure although this is not essential. This allows a saving on the expense for an inert gas, which would be significant particularly at the same time as the application or generation of the negative pressure.

Alternatively, the interior of the film bag may contain an inert gas, for example a standard inert gas for food such as carbon dioxide or nitrogen. Here too, the aforementioned negative pressure can preferably be present, but this is not essential.

In one embodiment of the invention, the negative pressure can, according to step C), be generated in the film bag in that elongate and inherently stable tubing or another extraction tube or extraction hose is inserted into or located in the not yet completely sealed film bag. Through it, air can be extracted from the film bag or negative pressure can be generated, wherein in particular the air is extracted while the film bag is being sealed, preferably airtight. The tubing should be pulled out before complete sealing of the film bag, i.e. as long as the film bag is only partially sealed.

In another embodiment of the invention, the negative pressure can be generated in the film bag according to step C) in that a negative pressure is generated in a laterally sealed film tube for several film bags. Several articles are always lined up one behind the other inside this film tube, and are advantageously moved largely continuously. A welding die extending transversely to the longitudinal direction or a so-called transverse welding unit can then seal off, or seal and separate, each first article in the film tube when outside a function unit generating the negative pressure. The transverse welding unit should be designed preferably to match the movement, at least for a short distance, so that it can seal off or seal and separate during such movement. The movement of the film bags or of the articles to be packaged thus does not have to be interrupted. An aforementioned extraction tube or the like for generating the negative pressure can then be immovable or static inside the film tube, advantageously in the region of the transverse welding unit, particularly advantageously 10 mm to 70 mm, for example 40 mm, away from it.

Such a transverse welding unit can be quite generally provided in order to subdivide the film bags in the longitudinal direction, and above all to weld and hence also seal them, preferably airtight.

In another further embodiment of the invention, gas and/or air can be pressed out of the film bag before complete sealing of the film bag, i.e. not by extraction. This can preferably be achieved in that pressure is applied or exerted on the film bag from one side, in particular from above, over a surface and softly or flexibly. This can be done with a soft elastic or yielding plate, brush or foam pad or the like. Alternatively, it can be done with compressed air, which has the advantage of lower wear and lower risk of damage.

Advantageously, a so-called barrier film can be used for packaging an article on a tray using a previously described method. Such a barrier film may have a thickness of between 10 μm and 100 μm, preferably between 10 μm and 50 μm or between 20 μm and 30 μm. It can advantageously be almost a monomaterial, and for example consist of 95% PE, wherein it can be multi-layer and two thin layers can consist of PE film. The barrier film can consist of 5% of a different material which forms a barrier layer between the two layers of PE film. This barrier layer prevents the ingress of bacteria, germs and the like. Such a barrier film has the major advantage that it can be very easily recycled. This also applies for an aforementioned tray if it consists for example of cardboard or paper material, even if it has a thin coating of wax, a thin film or the like to make the tray water-impermeable or moisture-resistant. For better recycling, however, this should be omitted; a separate absorbent fabric of compostable or recyclable material can be provided on the tray.

A further possible barrier film can be not only a polyolefin film with a barrier that is in principle shrinkable even if it is not shrunk in the context of the invention; any other barrier film, even in combination with a barrier paper, may also be used when there are two film webs. The barrier paper is used here as the tray, and the film is sealed onto the paper.

A device in accordance with the invention, with which the previously described method can be performed, has a side welding unit with two wheel pairs for welding the barrier film at the lateral sides of the articles. The wheel pairs are here arranged one behind the other in the movement direction of the articles, wherein in each of the wheel pairs two wheels are pressed against one another, wherein one wheel is preferably arranged above the other. At least one of the wheels of a wheel pair is heated. A heated wheel may consist of metal, preferably stainless steel, while the other wheel, against which it is pressed, has an elastic or soft outside face into which the metal wheel can press. This ensures dependable pressing together and welding of the barrier film. The wheel pairs move between them at least two layers, one lying on the other, of the barrier film and bond them to one another or seal them by welding in order to thus form the film bag. A similar side welding unit is known from DE 199 05 888 A1, which however has only a single wheel pair.

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into individual sections and sub-headings does not limit the statements made thereunder in their general validity.

### BRIEF DESCRIPTION OF THE DRAWINGS

Exemplary embodiments of the invention are illustrated schematically in the drawings and explained in more detail below. The drawings show in:

FIG. 1 a side view onto a salmon fillet in a dish-like tray made of cardboard to be packaged in the following,

FIG. 2 the tray with the salmon fillet from FIG. 1 wrapped in a film bag,

FIG. 3 a plan view onto the film bag from FIG. 2,

FIG. 4 a simplified representation during a packaging method for the tray together with the salmon fillet from FIG. 2, wherein air is extracted from the not yet sealed film bag,

FIG. 5 a plan view onto a film bag closed at the edges according to FIG. 3 with an air outlet hole,

FIG. 6 a representation similar to FIG. 5 with film bag, wherein the air outlet hole has been sealed airtight using a sticker,

FIG. 7 a lateral representation of one possibility for exertion of pressure form-elastically onto the film bag according to FIG. 4, before the air outlet hole is sealed,

FIG. 8 a representation of a film bag similar to FIG. 3 with a pressure relief valve on its upper side,

FIG. 9 a representation of packaging similar to FIG. 2, which is wrapped with paper banderoles of differing width, and

FIG. 10a simplified representation of a side welding unit with two wheel pairs for welding of the film bag.

### DETAILED DESCRIPTION OF THE EXAMPLES

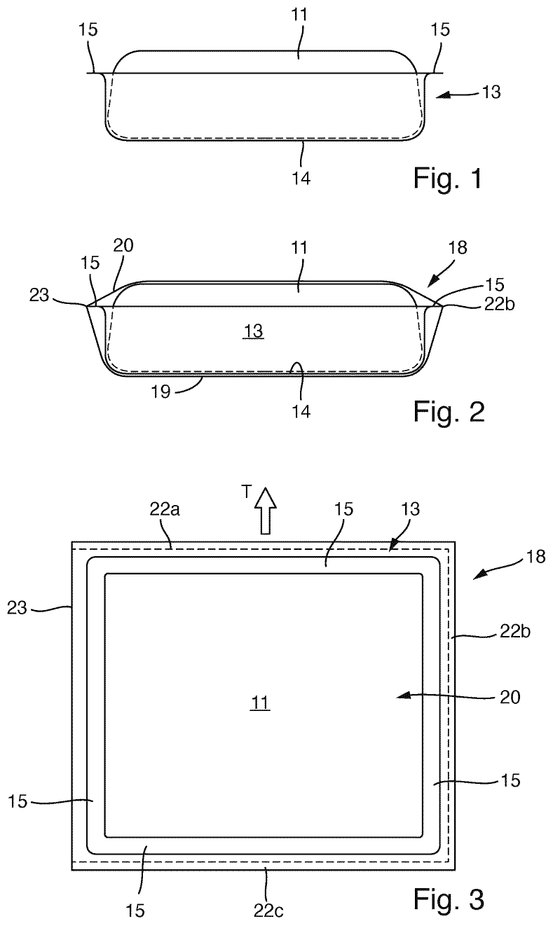

FIG. 1 shows a piece of salmon fillet 11 as the food or the article to be packaged, placed on a tray 13. The tray 13 consists of cardboard, possibly with a very thin coating on its upper side towards the salmon fillet 11. Alternatively, a separate mat of absorbent fabric may be provided. The tray 13 should advantageously be free of plastic and/or recyclable. It is designed dish-like with a tray bottom 14 and an upward-curved and outward-projecting all-round tray rim 15. This is also shown by a comparison with the representation in FIG. 3. Trays 13 of this type are known from the prior art. Due to a separate mat made of absorbent fabric, the cardboard tray 13 cannot be soaked by the juice from the salmon fillet 11, and thus remains firm.

This combination of salmon fillet 11 on the tray 13 must now be packaged inside a film bag for sale. Advantageously, this is done in the factory in which the salmon is also cut into the salmon fillets 11. FIG. 2 shows such a film bag 18 around the tray 13 with salmon fillet 11 inside, wherein the film bag 18 here closely conforms to the shape or contour of the tray 13 with the salmon fillet 11 inside. One advantage of this close contact is that the combination of tray 13 with salmon fillet 11 inside it is somewhat stabilized. The film for the film bag 18 is a special barrier film or a so-called EVOH film as was described at the outset. It is however advantageously possible also to use one of the other films mentioned at the outset. The film bag 18 could also be designed somewhat loose or with more space around the tray.

The film bag 18 is shown in FIG. 3, in a plan view for better comprehension, with a transport direction T. The film bag 18 has an underside 19, an upper side 20 and three all-round lateral weld seams 22a, 22b and 22c. On the fourth side 23, i.e. on the left, the film extends all the way from the underside 19 to the upper side 20. The film bag 18 is therefore formed with an aforementioned film half-tube and must therefore be bonded only on three sides by means of thermal welding.

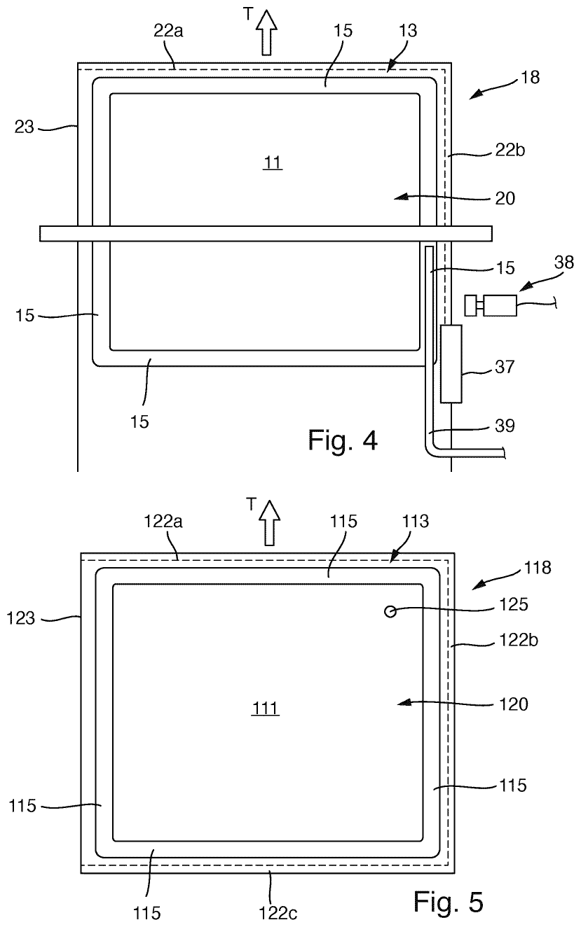

The edge weld seams 22a to 22c seal the film bag 18 airtight, so that no impurities or germs can pass into the film bag 18 and reach the salmon fillet 11. To prevent any problems with air and possibly germs inside the closed film bag 18, negative pressure can be generated inside the film bag 18 or air can be extracted from it during welding according to FIG. 4. FIG. 4 shows this in a very simplified and schematic form, in that the tray 13 with the salmon fillet 11 has already been wrapped inside the film half-tube at the upper side and the underside, as is known from the aforementioned prior art. The front edge weld seam 22a is already made by separation of the per se continuous film half-tube by means of a transverse welding unit 35 shown in simplified form. This front edge weld seam 22a extends over the entire width and seals the film bag here, or bonds the underside 19 and the upper side 18 firmly and airtightly to one another.

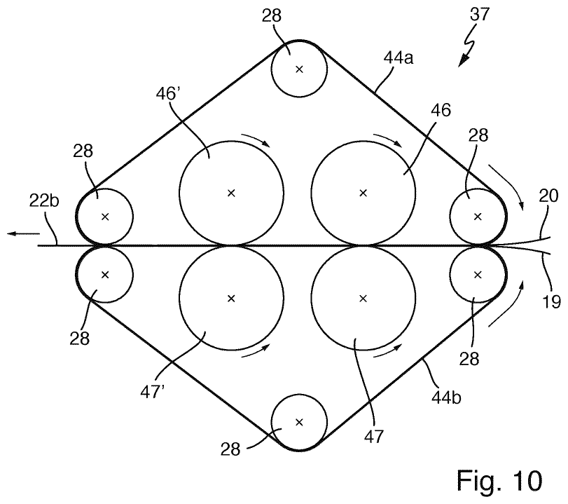

The right-hand edge weld seam 22b is also completely made, by means of a side welding unit 37 also known from the prior art. Side welding units 37 of this type are known for example from DE 199 05 888 A1 or DE 10 2006 018 083 A1. A side welding unit in accordance with the invention is also shown in the following in FIG. 10, and ensures considerably better and more secure welding due to the two wheel pairs used. This can ensure that the film bag is also actually airtight. Corresponding transverse welding units are known for example from DE 10 2011 075 532 A1. A camera 38 is arranged on the side welding unit 37 and is part of a monitoring device using which a quality or a required and correct completion of the edge weld seam 22b on the side can be monitored. Should any quality problems arise here, the appropriate packaging can be directly ejected and disposed of, or the tray 13 inside it together with the salmon fillet 11 can be repackaged.

On that side of the tray 13 or of the film bag 18 which is at the rear in the transport direction T, and on which the edge weld seam 22c is to be made according to FIG. 3, an extraction tube 39 is inserted from the rear into the film bag 18 still open in this area. With it, air can be extracted from the film bag 18 or a negative pressure can be generated inside it. This effects a contact of the underside 19 of the film bag with the tray bottom 14 from underneath and with its side walls, and above all contact of the upper side 20 of the film with the upper side of the salmon fillet 11. Due to the latter's usually slightly moist upper side, the film also sticks to it, which has the advantage that no air can flow into it. From FIG. 4 it may be discerned that during transport of the film bag 18 with the tray 13 and the salmon fillet 11 inside it along the transport direction T, the extraction tube 39 slips out of it or no longer projects into it, and hence can no longer generate any negative pressure. Air could therefore easily flow into it again. For that reason, the transverse welding unit 35 is close to the extraction tube 39 as may be discerned in the plan view. As soon as the rear tray rim 15 is underneath the transverse welding unit 35 or slightly further past it, the transverse welding unit 35 welds the underside 19 and the upper side 20 of the film bag 18 and seals the latter. The extraction tube has been pulled out of the film bag just before that. Due to the aforementioned circumstances, this can be effected in such a way that there is always still an at least slight negative pressure prevailing in the now closed film bag 18.

Since the next film bag with a tray 13 with salmon fillet 11 inside is immediately transported into place behind the film bag 18 according to FIG. 4, the extraction tube 39 cannot remain stationary in this position. Depending on circumstances, it must be re-inserted every time from the rear into a partially closed film bag. Alternatively, the film half-tube can keep moving continuously, with trays 13 inside, towards the rear tray rim 15 where the edge weld seam 22c is placed. It can then be sufficient if the extraction tube 39 projects into this film half-tube long before the transverse welding unit 35 and side welding unit 37, for example 1 m or 2 m, and extracts air. Air can keep flowing into the film half-tube on the right-hand side in each case, while at the front side the edge weld seam 22a is of course always sealed by means of the transverse welding unit 35. However, despite this air inflow a negative pressure can be maintained inside the film bag until the moment at which it is sealed using the transverse welding unit 35 and hence also separated from the remaining film half-tube, which favors air extraction.

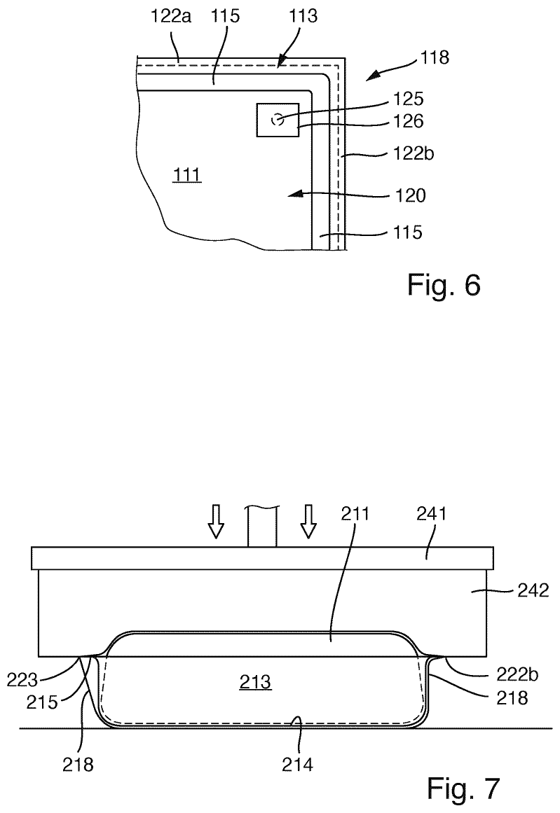

An aforementioned alternative possibility to avoid or compensate for the possibly occurring problem of a volume expansion due to possible heating up is shown in FIGS. 5 and 6. The plan view onto FIG. 5 shows in accordance with FIGS. 2 and 3 a completely sealed film bag 118 with a tray 13 together with salmon fillet 111 inside it. The film bag 118 is continuous on the left-hand free side 123, since it has been formed from a film half-tube as previously described. At the edge weld seams 122a, 122b and 122c, it is welded in accordance with the illustration in FIG. 4. On an upper side 120, the film bag 118 has however an air outlet hole 125 which may have a diameter of, for example, 2 mm or 3 mm. This may be provided in different ways. It can be manufactured by puncturing, or alternatively by a thermal effect, to strengthen the edges of the air outlet hole 125 such that it cannot be so easily torn open further. It could also be positioned close to one of the edge weld seams 122a to 122c instead of on the upper side 120.

After packaging, a sticker 126 can then be affixed to the upper side 120 and over the air outlet hole 125 in accordance with FIG. 6. This sticker 126 can advantageously also contain information on the contents of the film bag 118, alternatively on its specific packaging type, for example a brand name for this specific type of packaging. This prevents aforementioned impurities or germs from getting into the film bag 118 through the air outlet hole 125 and reaching the salmon fillet 111.

FIG. 7 shows a possibility for removing as much air as possible from a film bag 218 according to FIG. 5 using an air outlet hole not discernible in FIG. 7. To do so, the film bag 218 with tray 13 and salmon fillet 211 inside it can be placed onto a base surface. A kind of soft die 241, for example with an elastic foam underside 242, moves in from above. The foam underside 242 is soft enough that it practically presses air out of the film bag 218, allowing it to escape through the air outlet hole. At the same time, however, it does not damage or impair the contents of the film bag 218. Alternatively to such a die 241, blowing using compressed air from above, optionally from underneath too in addition, could also take place, having the same effect on the entire film bag 218 with its content. After removal of the die 241 or stopping of the compressed air, it is possible to reseal the air outlet hole as previously explained, for example by means of a sticker as mentioned, see FIG. 6. This allows as much air as possible, which possibly contains germs, to be removed from the film bag 218 through the air outlet hole.

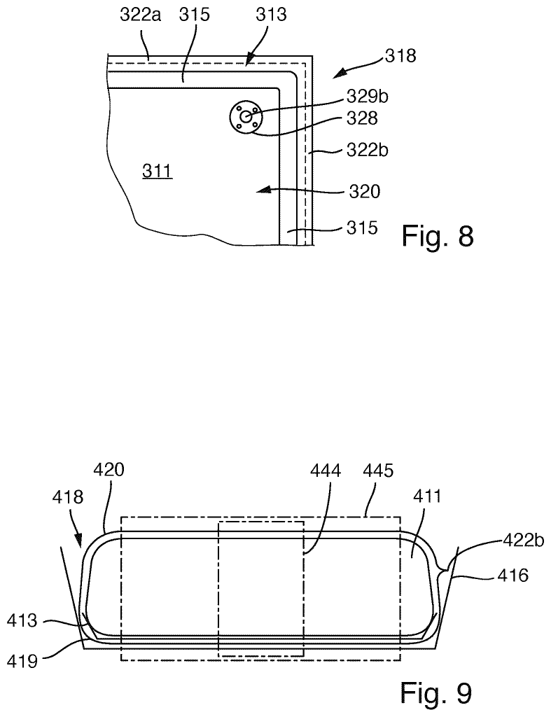

Another possibility in accordance with the aforementioned step D) is shown in FIG. 8. In this case, a pressure relief valve 328 is provided on an upper side 320 of a film bag 318 with tray 13 and salmon fillet 311 inside. The valve can be positioned for example at an air outlet hole similar to FIG. 5, advantageously after making of the film bag 318, finished per se, with edge weld seams 322a to 322c. Pressure relief valves 328 of this type are generally known from food packaging, for example from bags for coffee beans. They have a central outlet opening 329 and on the inside a diaphragm or the like, not discernible. Any excess gas mixture can be actively extracted from the packaging or from the film bag 318 through this valve by means of an extraction device. If a positive pressure builds up in the interior of the film bag 318, for example due to possible heating up of the air inside it as previously described, which expands its volume, the air can escape through the pressure relief valve 328 and the outlet opening 329. The positive pressure thus drops without any problem. The pressure relief valve 328 is airtight in the other direction. This means that the film can contract, since the excess air or contained air can escape. After or even during cooling, however, no air can flow into the film bag, which is also an advantage for hygiene reasons relating to germs and the like.

In a further embodiment of the invention, it may be provided that the tray 13 with the salmon fillet 11 inside is inserted into a pre-printed film such that its imprint is located at the precise position as required and predetermined, in particular on an upper side 20.

FIG. 9 shows, in a representation similar to that in FIG. 2, another further possibility for packaging and secondary packaging of salmon fillet 411 as the article. The salmon fillet 411 is here placed either without any tray or as previously described on a flat tray 413 of thin card. An absorbent fabric as previously described can be placed between them. Around them, a film bag 418 is made by completely wrapping the tray 413 with salmon fillet 411 thereon in a corresponding barrier film, the film bag 418 having an upper side 420 and a edge weld seam 422b shown on the right.

The film bag 418 is placed in turn into a stable outer dish 416 which may consist of card or plastic, as has been previously described. This outer dish 416 is intended to ensure sufficient stability for the entire packaging for handling during transport, presentation in a display of a store, purchasing and further transport. It can have closed surfaces, lateral outer sides and an underside, but these may also be partially cut out or have openings or may even be designed skeleton-like with relatively thin ribs.

A first possibility for fixing the film bag 418 inside the outer dish 416 consists of glueing it on the upper side of the bottom of the outer dish 416. A second possibility consists of providing a relatively narrow banderole 444, shown as a dashed line, advantageously made of paper or thin film. An imprint or a sticker with information on the product or salmon fillet 411 may also be attached to this banderole, for example. Alternatively to the relatively narrow banderole 444, a relatively wide banderole 445 shown as a dash-dotted line may be provided. Under some circumstances, it can be designed even wider and thus enclose or wrap the entire outer dish 416. Preferably, the banderoles 444 and 445 consist of paper or recyclable plastic. They should be relatively close-fitting, enabling additional stabilization of the entire packaging.

Another further and third possibility, not shown here, is to provide at least one narrow strip in the manner of a narrow banderole in the wrapping direction according to FIG. 9. A further relatively narrow strip should be provided rotated 90 degrees thereto, such that the two strips are at right angles to one another when seen in the plan view. So-called straps of this type are also known from other packaging. They prevent, similarly to the banderoles 444 and 445, the film bag 418 being separated from or falling out of the outer dish 416. Furthermore, they can achieve additional stability for simpler packaging.

As a general principle, in FIG. 9 the film bag 418 can and should be in tighter contact with the salmon fillet 411 on the tray 413. Above all, this film bag 418 should be in full-surface and flat contact directly with the upper side of the outer dish 416. One of the two banderoles 444 or 445 shown should then also be passed around relatively tightly. The slightly exploded or loose representation shown here differs from that, in order to show the details better.

FIG. 10 shows the side welding unit 37 in accordance with the invention from the side. On the right, the upper side 20 and the upper side 19 of the film pass in, and on the left they pass out as the edge weld seam 20b. Here they are welded to one another airtight, and any excess can be cut off. The side welding unit 37 has an upper all-round belt 44a and a lower all-round belt 44b. The belts 44a and 44b pass around deflecting rollers 28. These deflecting rollers 28 are driven, and they rotate the belts 44a and 44b and keep them taut. The belts 44a and 44b are used above all to press together and convey the films 19 and 20.

A first wheel pair, with an upper separating/welding wheel 46 and a lower counter wheel 47, is arranged inside the belt, coming from the right. In the movement direction, behind it and on the left, a second wheel pair with an upper separating/welding wheel 46′ and a lower counter wheel 47′ is arranged. The two wheel pairs and the respective wheels can be designed similar or identical. The wheel pairs or at least one of the wheels of each wheel pair are driven, advantageously synchronously. In the area in which they contact one another, the two films 19 and 20 are bonded to one another by welding, and any excess is cut off and can be collected and removed. The belts 44a and 44b run next to the wheel pairs.

The upper separating/welding wheels 46 and 46′ have on an outer face an all-round projecting rib or projection, while the remainder of the outer face is flat. The outer faces and advantageously the entire separating/welding wheels 46 and 46′ consist of metal and are hard. Advantageously, they can be directly heated, which is not shown here, wherein it is above all important that they are heated on the outer face or on the all-round projecting rib or projection. In this way they separate the films 19 and 20 and weld them to one another to seal the finished film bag airtight. An outer face of the lower counter wheels 47 and 47′ is advantageously flat and consists of elastic material, for example rubber, partially flexible material such as fluoroelastomer or silicone rubber. It can have a Shore hardness of between 50 and 150 Shore A. The upper separating/welding wheels 46 and 46′ and the lower counter wheels 47 and 47′ can each be designed as known from the aforementioned DE 199 05 888 A1.

1. A method for packaging an article in a film, wherein the film is a barrier film which is impenetrable for bacteria and germs and wherein the method has the following steps:
A) provision of a tray and of the article on the tray, wherein the tray projects beyond the article at the sides when seen in the plan view,
B) complete wrapping of the tray with the article thereon in the barrier film,
C) complete sealing of the barrier film around the tray with the article thereon in order to form a film bag,
D) alternatively to step C), complete sealing of the barrier film around the tray with the article thereon in order to form a film bag, wherein the finished film bag is provided with a pressure relief valve attached to the barrier film,
wherein the film bag is sealed by means of thermal welding of at least two layers of the barrier film lying one above the other.

2. The method according to claim 1, wherein the barrier film has a thickness of between 10 μm and 100 μm.

3. The method according to claim 1, wherein the barrier film is sealable or has two film layers of PE with a barrier layer between them.

4. The method according to claim 1, wherein the barrier film is selected from the group: EVOH, PE, PO, LDPE, HDPE, VCI, ESD.

5. The method according to claim 1, wherein a negative pressure is generated in the film bag, such that the film bag is sealed with negative pressure inside it, wherein the negative pressure is generated and maintained during the complete sealing operation.

6. The method according to claim 1, wherein a negative pressure has been generated in step C) or in step D) in the film bag after complete sealing, wherein the negative pressure is between 0.01 bar and 0.9 bar.

7. The method according to claim 1, wherein the tray with the article thereon is first inserted into the barrier film such that the barrier film is underneath the tray and on a first lateral side upwardly overlaps onto the tray together with the article thereon over the full length and without interruption, wherein on the opposite second lateral side, both film layers can project beyond the tray and the article thereon, wherein the two film layers on this second lateral side can then be welded to one another.

8. The method according to claim 7, wherein the two film layers on the second lateral side are welded to one another at a distance from the second lateral side which is less than 20% of the distance of the two lateral sides from one another.

9. The method according to claim 7, wherein welding takes place at least on the second lateral side during movement, wherein in particular welding is done by means of a side welding unit with two heated wheel pairs, which are arranged one behind the other in the movement direction of the articles, wherein in each of the wheel pairs two wheels are pressed against one another and transport between them two layers, one lying on the other, of the barrier film and bond them to one another and seal them by welding in order to form the film bag.

10. The method according to claim 7, wherein during packaging into the barrier film the tray with the article thereon is moved along a transport direction, wherein the two film layers are bonded to one another in a direction transverse to that transport direction by welding to a front side of the tray when seen in the transport direction.

11. The method according to claim 10. wherein the film bag is finally sealed by welding of the two film layers to one another at a rear side opposite to the front side.

12. The method according to claim 1, wherein the interior of the film bag contains normal air and not an inert gas.

13. The method according to claim 1, wherein the interior of the film bag contains inert gas.

14. The method according to claim 5, wherein the negative pressure is generated in the film bag in that elongate and inherently stable tubing is inserted into the not yet completely sealed film bag, and then air is extracted from the film bag through the tubing, wherein the air is extracted while the film bag is being sealed in step C), wherein the tubing is pulled out of the partially sealed film bag before complete sealing of the film bag.

15. The method according to claim 5, wherein the negative pressure is generated in the film bag in step C) in that a negative pressure is generated in a laterally sealed film tube in which several articles are lined up one behind the other, wherein a welding die extending transversely to the longitudinal direction seals and separates each first article in the film tube outside a unit generating the negative pressure.

16. The method according to claim 15, wherein an extraction tube for generating the negative pressure is immovable or static inside the film tube.

17. The method according to claim 1, wherein alternatively to step C) or D) gas and air are pressed out of the film bag before complete sealing of the film bag, in that pressure is applied to the film bag from one side over a surface and softly or flexibly.

18. The method according to claim 17, wherein pressure is applied to the film bag from one side over a surface and softly or flexibly with a soft elastic plate or with compressed air.

19. Use of a barrier film for packaging an article on a tray using a method according to claim 1, wherein the barrier film has a thickness of between 10 μm and 100 μm and is a multi-layer film.

20. A device for performing the method according to claim 1, wherein it has for welding the barrier film on the lateral sides of the articles a side welding unit with two wheel pairs, wherein the wheel pairs are here arranged one behind the other in the movement direction of the articles, wherein in each of the wheel pairs two wheels are pressed against one another and move between them two layers, one lying on the other, of the barrier film and bond them to one another and seal them by welding in order to form the film bag.

21. The device according to claim 20, wherein at least one of the wheels of a wheel pair is heated.

22. The device according to claim 21, wherein exactly two pairs of wheels are provided which are identically configured, and wherein, in each of the pairs of wheels, exactly one of the wheels of that pair is heated.
